(19) United States
(12) Patent Application Publication
(10) Pub. No.: US 2025/0155648 A1
(43) Pub. Date: May 15, 2025

(54) FIBER ARRAY UNIT INTEGRATED WITH LIGHT GUIDING ELEMENTS AND METHOD FOR FORMING THE SAME

(71) Applicant: Taiwan Semiconductor Manufacturing Company, Ltd., Hsinchu (TW)

(72) Inventors: Tung-Liang SHAO, Hsinchu (TW); Yu-Sheng HUANG, Changhua County (TW); Chen-Hua YU, Hsinchu City (TW)

(21) Appl. No.: 18/507,402

(22) Filed: Nov. 13, 2023

(51) Int. Cl. G02B 6/36

(52) U.S. Cl. CPC G02B 6/3636; G02B 6/3688

(57) ABSTRACT

A fiber array unit (FAU) and the method for forming the same are provided. The FAU includes a substrate, fiber grooves, and light guiding elements. The substrate has a first region and a second region which are continuous and connected. The fiber grooves are formed in the first region. The light guiding elements are formed in the second region. The fiber grooves are aligned with the light guiding elements, respectively.

### BACKGROUND

One technique for signal transmission and processing is electrical signaling and processing. In addition, optical signaling and processing has been used in an increasing number of applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as for processing and control. Accordingly, devices that integrate optical components and electrical components are produced to perform conversion between optical signals and electrical signals, as well as for the processing of optical signals and electrical signals. Packages (also referred to as photonic packages) may therefore include both photonic dies including optical devices and electronic dies including electronic devices.

A fiber array unit (FAU) may have multiple grooves, with an optical fiber held within each groove, and may be used to optically couple light from some light sources to the fibers, and from the fibers to optical couplers within the photonic die of a photonic package. Optical glue is typically used to attach the FAU to the photonic package. After the optical glue has been dispensed between the FAU and the photonic package, it can be cured, e.g., by ultraviolet (UV) curing.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIGS. 1A, 1B, and 1C illustrate various views of a fiber array unit, in accordance with some embodiments.

FIGS. 2A, 2B, and 2C illustrate various views of a fiber array unit, in accordance with some embodiments.

FIGS. 2B-1 and 2B-2 illustrate some alternatives of the fiber array units in FIG. 2B.

FIGS. 3A, 3B, and 3C illustrate various views of a fiber array unit, in accordance with some embodiments.

FIG. 4 illustrates a flow chart of a method of forming a fiber array unit, in accordance with some embodiments.

FIGS. 5A, 5B, and 5C illustrate various views of a fiber array unit, in accordance with some embodiments.

FIGS. 6A, 6B, and 6C illustrate various views of a fiber array unit, in accordance with some embodiments.

FIGS. 7A, 7B, and 7C illustrate various views of a fiber array unit, in accordance with some embodiments.

FIG. 8 illustrates a flow chart of a method of forming a fiber array unit, in accordance with some embodiments.

FIGS. 9 to 12 illustrate cross-sectional views of intermediate steps of forming a photonic package, in accordance with some embodiments.

FIGS. 13 and 14 illustrate cross-sectional views of intermediate steps of forming a semiconductor package, in accordance with some embodiments.

FIGS. 15 to 17 illustrate cross-sectional views of intermediate steps of forming a photonic system, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The system may be otherwise oriented (rotated 90 degrees or at other orientations) and the spatially relative descriptors used herein may likewise be interpreted accordingly.

A photonic system including a fiber array unit (FAU) that optically couples optical fibers to a photonic die within a semiconductor package and the method for forming the same are provided in accordance with some embodiments of the present disclosure. In some embodiments of the present disclosure, the support substrate of the FAU is an ultraviolet (UV)-transparent substrate that allows UV light to pass through during the curing process to cure the optical glue used to secure the FAU to the semiconductor package. In some embodiments, the FAU integrates fiber grooves and light guiding elements (e.g., waveguides and/or reflectors) on a single support substrate, which can eliminate additional assembly alignment between the fiber grooves and the light guiding elements, thereby reducing the number of steps to manufacture the FAU. Also, the optical performance of the FAU can be improved due to the omission of an adhesive interface (such as optical glue) between the fiber grooves and the light guiding elements.

The Embodiments discussed herein provide examples to enable making or using the subject matter of this disclosure, and a person having ordinary skill in the art will readily understand that modifications can be made while remaining within the contemplated scope of different embodiments. Throughout the various views and illustrative embodiments, like reference numbers are used to designate like elements.

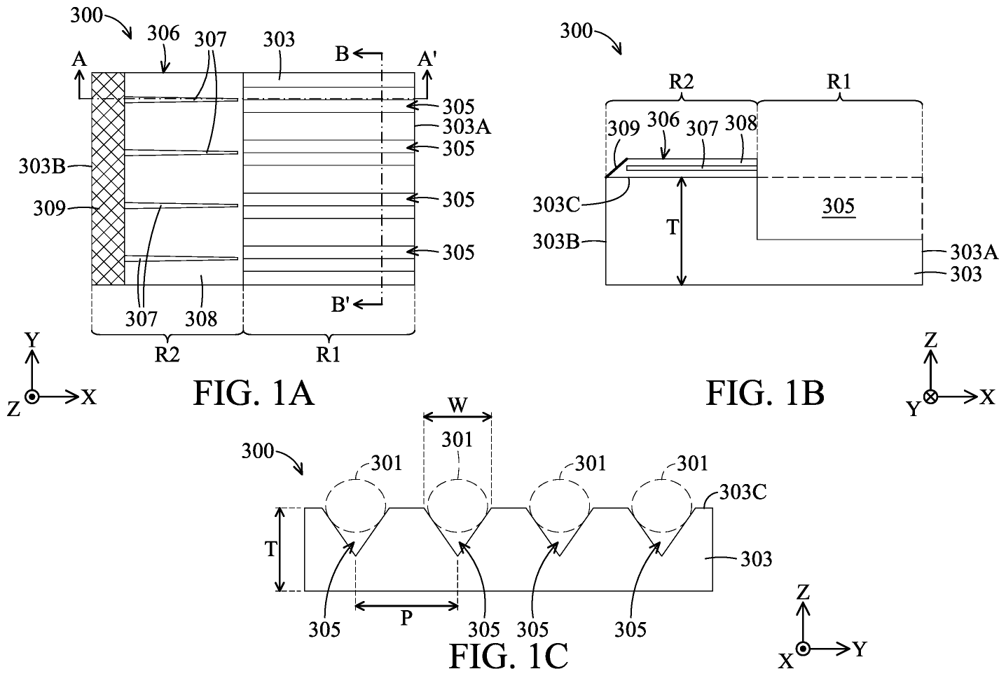

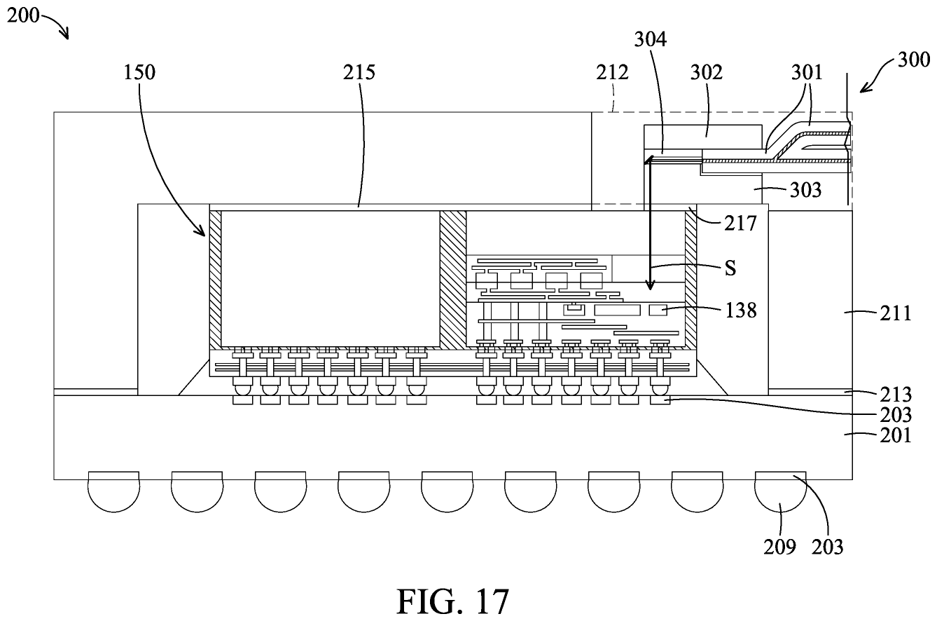

Referring to FIGS. 1A to 1C, which illustrate various views of a FAU 300, in accordance with some embodiments. FIG. 1A illustrates a top view of the FAU 300, FIG. 1B illustrates a cross-sectional view of the FAU 300 taken along the line A-A′ in FIG. 1A, and FIG. 1C illustrates a cross-sectional view of the FAU 300 taken along the line B-B′ in FIG. 1A. Note that for simplicity, not all details of the FAU 300 are illustrated in all of the figures. For example, a cover 302 and optical glue 304 included in the FAU 300 are omitted in the figures (but illustrated in FIG. 17), and optical fibers 301 are only shown in FIG. 1C.

As shown in FIGS. 1A, 1B and 1C, the FAU 300 includes a (support) substrate 303 configured to support and hold the optical fibers 301. The substrate 303 may have a rectangular shape in a plan view (see FIG. 1A) and a rectangular shape in cross-sectional view (see FIGS. 1B and 1C), although other shapes may be used. The substrate 303 has opposite first and second ends (303A and 303B) in its longitudinal axis direction (e.g., the X-axis direction shown), where the second end 303B is adjacent to a semiconductor package 150 to which the FAU 300 is to be attached (e.g., see FIG. 17). In addition, the substrate 303 has a first region R1 for arranging fiber grooves 305 and a second region R2 for arranging light guiding elements (e.g., waveguides 307 and reflectors 309), where the first region R1 and second region R2 are arranged and connected along the longitudinal axis of the substrate 303 (e.g., the X-axis direction shown). The first region R1 is adjacent to the first end 303A, and the second region R2 is adjacent to the second end 303B. In some cases, the thickness T of the substrate 303 may be in a range between 100 μm and 2000 μm, although smaller or larger thicknesses may be used.

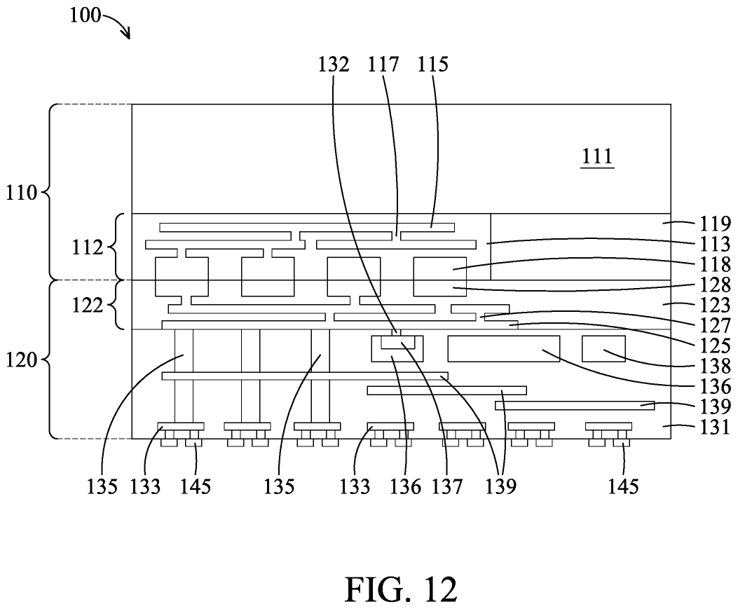

The substrate 300 may comprise a material that is substantially transparent to light at wavelengths suitable for transmitting optical signals or optical power between a grating couplers 138 of a photonic die 120 (e.g., see FIG. 12) within the semiconductor package 150 and the optical fibers 301. In some embodiments, the substrate 300 comprises a UV-transparent material (e.g., glass) in order to allow UV light to pass through during the curing process to cure the optical glue 217 (e.g., see FIG. 17), as mentioned above. Other suitable materials may also be used in other embodiments, such as sol-gel glass or a UV-transparent polymer (e.g., PDMS, SU8, PMMA, or the like) that allows light (e.g., UV light) to pass through.

Fiber grooves 305 (e.g., recesses) are formed in the substrate 303 (e.g., on the upper surface 303C of the substrate 303). The fiber grooves 305 are disposed in the first region R1 of the substrate 303 (for example, extending from one end of the first region R1 to the opposite end, as illustrated in FIGS. 1A and 1B), and are parallel to each other. For example, in a plan view (see FIG. 1A), each of the fiber grooves 305 may extend along the longitudinal axis of the substrate 303 (e.g., the X-axis direction shown), and those fiber grooves 305 are arranged in parallel in a direction (e.g., the Y-axis direction shown) perpendicular to the longitudinal axis direction. The fiber grooves 305 can be designed with a dimension (e.g., the maximum width W) and spacing (e.g., pitch P) corresponding to the dimension (e.g., diameter) and spacing (e.g., pitch) of the optical fibers. In some embodiments, each fiber groove 305 has a V-shaped cross-section as illustrated in FIG. 1C, although other suitable cross-sectional shapes (e.g., U-shaped) may be used.

In some embodiments, the fiber grooves 305 are formed using an imprinting process. For example, in cases where the substrate 303 is made of glass material, the imprinting process temperature should be higher than the glass transition temperature (Tg) of the type of glass used in order to form the fiber grooves 305. Other processes suitable for forming the fiber grooves 305 in the substrate 300 (e.g., glass substrate) may also be used in other embodiments, such as molding, mechanical cutting, laser cutting, chemical etching, and the like.

A waveguide structure 306 is formed over the substrate 303. The waveguide structure 306 includes waveguides 307 formed (e.g., embedded) in one or more dielectric layers 308 on the upper surface 303C of the substrate 303. The waveguide structure 306 is disposed in the second region R2 of the substrate 303 (for example, extending from one end of the second region R2 to the opposite end, as illustrated in FIGS. 1A and 1B). In a plan view (see FIG. 1A), the waveguides 307 (of the waveguide structure 306) are parallel to each other and aligned with the fiber grooves 305 in a one-to-one fashion. In addition, although not shown, the waveguides 307 are positioned such that the core of each optical fiber 301 (held by a fiber groove 305) is aligned with the corresponding waveguide 307 (i.e., they are at the same vertical height) in cross-sectional view to allow optical coupling between the optical fibers 301 and the respective waveguides 307.

In some embodiments, the refractive index of the material of the waveguides 307 is higher than the refractive index of the material of the dielectric layers 307. For example, the waveguides 307 may comprise silicon nitride, and the dielectric layers 308 may comprise silicon oxide. However, other materials suitable for the waveguides 307 and dielectric layers 308 may also be used.

The one or more dielectric layers 308 may be formed by any acceptable deposition process, such as spin coating, chemical vapor deposition (CVD), laminating, the like, or a combination thereof. In some embodiments, the waveguides 307 are nitride (e.g., silicon nitride) waveguides formed by patterning a silicon nitride layer using acceptable lithography and etching processes. Note that silicon nitride has a higher dielectric constant than silicon, and therefore a nitride waveguide may have a greater internal confinement of light than a silicon waveguide. This may also allow the performance or leakage of nitride waveguides to be less sensitive to process variations, less sensitive to dimensional uniformity, and less sensitive to surface roughness (e.g., edge roughness or linewidth roughness).

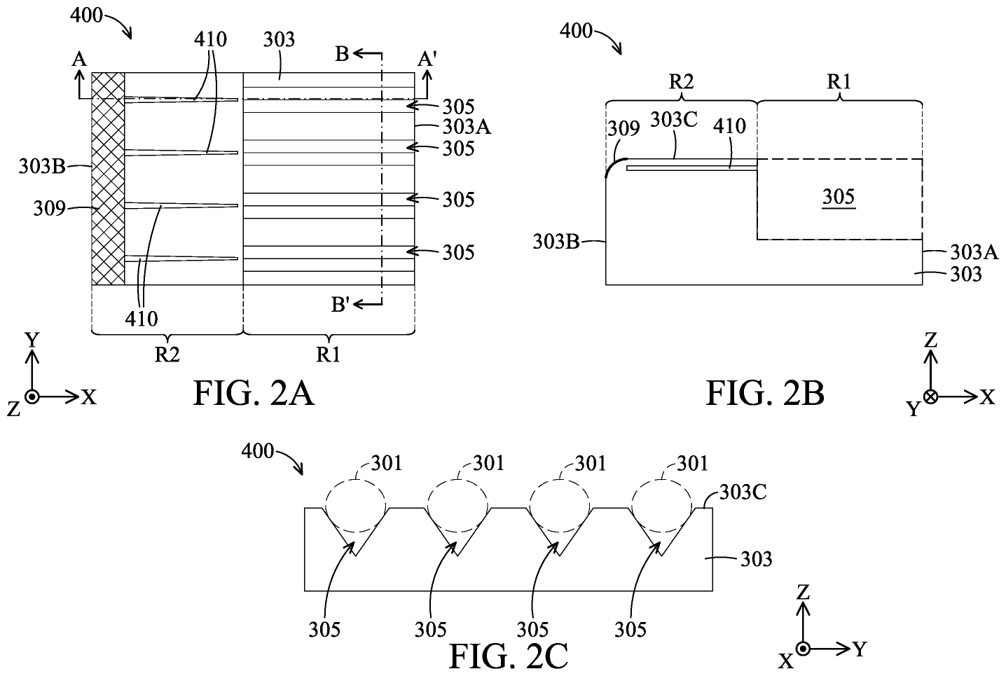

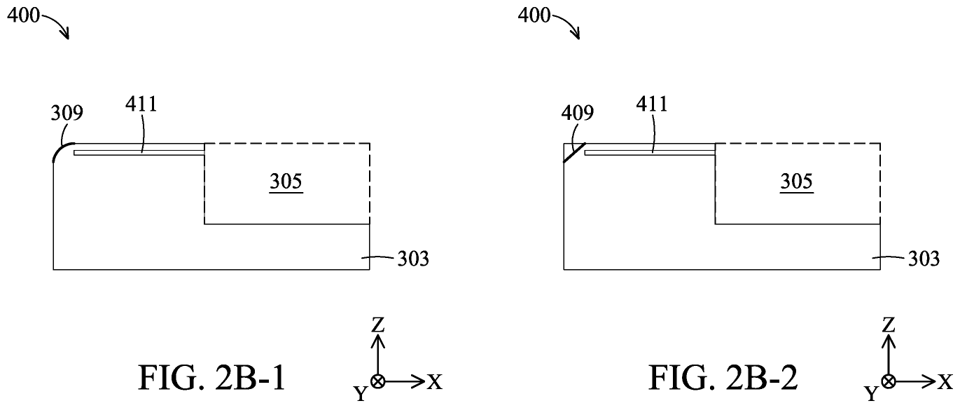

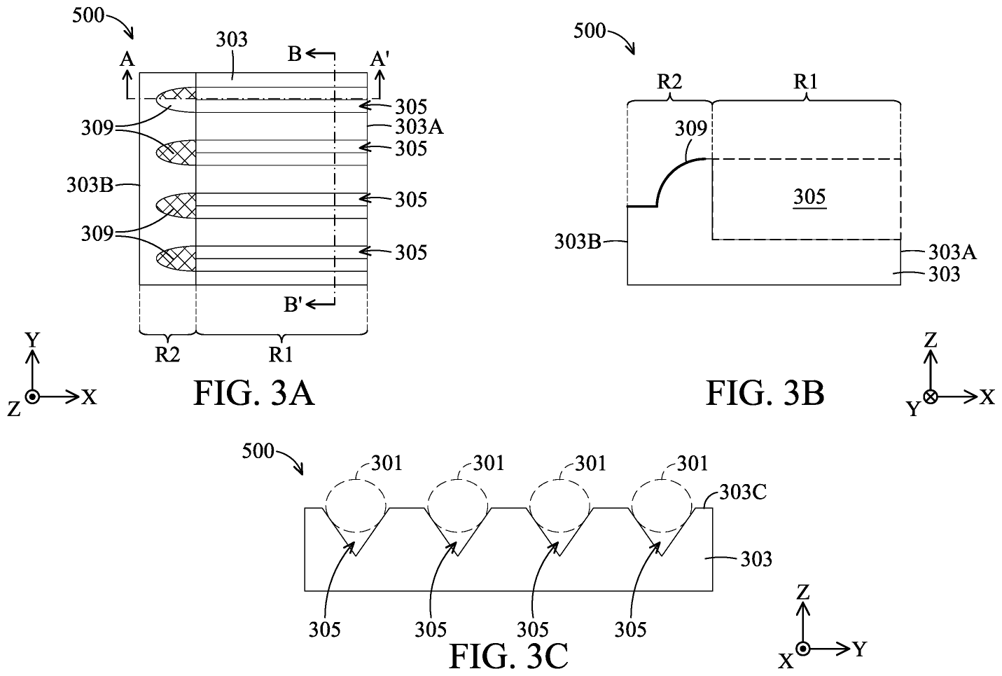

One or more (light) reflectors 309 are formed on the end of the waveguide structure 306 near the second end 303B of the substrate 303. The one or more reflectors 309 are used to guide (e.g., re-direct) light from the waveguides 307 to the corresponding grating couplers 138 within the semiconductor package 150, or vice versa. One reflector 309 is shown in FIGS. 1A-1C, but the FAU 300 may include more separate reflectors 309 corresponding to the number of the waveguides 307 in other embodiments (e.g., see FIGS. 3A-3C). In some embodiments, the reflector 309 has a plane structure that is inclined with respect to the upper surface 303C (e.g., forming an inclination angle of about 30 to 60 degrees with the upper surface 303C, such as 45 degrees), as illustrated in FIG. 1B. In other embodiments, the reflector 309 may alternatively have a curved cross-section (e.g., see FIGS. 2A2C, 2B-1, 3A-3C, 6A-6C, and 7A-7C). In the various embodiments discussed herein, oblique cross-section and curved cross-section may be used interchangeably.

The one or more reflectors 309 may be formed by forming one or more reflective surfaces (not marked separately) at the end of the waveguide structure 306 opposite the optical fibers 301, and then forming one or more reflective coatings on the one or more reflective surfaces. In some embodiments, the one or more reflective surfaces may be formed using any acceptable processes such as imprinting, molding, mechanical cutting, laser cutting, chemical etching, or the like. In some embodiments, the one or more reflective coatings may be a single-layered metal, and the metal material used includes gold (Au), silver (Ag), copper (Cu), aluminum (Al), titanium (Ti), tantalum (Ta), the like, the alloy thereof, or a combination thereof. Alternatively, the one or more reflective coatings may be a multi-layered structure including multiple sub-layers, each sub-layer being formed from the above metal materials or other suitable dielectric materials (e.g., silicon oxide (SiO₂), hafnium oxide (HfO₂), tantalum oxide (Ta₂O₅), titanium oxide (TiO₂), silicon nitride (SiN), amorphous silicon, etc.). The one or more reflective coatings may be formed using any acceptable process, such as CVD, physical vapor deposition (PVD), atomic layer deposition (ALD), or other suitable deposition processes.

With the above configuration, the FAU 300 integrates the fiber grooves 305, waveguides 307 and reflector(s) 309 on a single/monolithic substrate 303. In this manner, no additional assembly alignment between the fiber grooves 305 and the light guiding elements (e.g., 307 and 309) is required, thereby reducing the number of steps to manufacture the FAU 300. The optical performance of the FAU 300 can also be improved due to the omission of an adhesive interface (such as optical glue) between the fiber grooves and the light guiding elements. In addition, in some cases, the substrate 303 may be a UV-transparent substrate, such as a glass substrate (and the waveguide structure 306 is made of UV-transparent materials) to allow UV light to pass through during the curing process to cure the optical glue 217 (see FIG. 17).

FIGS. 2A-2C, 2B-1, 2B-2, 3A-3C, 5A-5C, 6A-6C, and 7A-7C illustrate various views of FAUs, in accordance with some alternative embodiments. It should be noted that the figure with the letter A in the figure number shows a top view of a FAU, and the figure with the letter B in the same figure number shows a cross-sectional view of the FAU taken along the line A-A′ in the figure with the letter A in the same figure number, and the figure with the letter C in the same figure number shows a cross-sectional view of the FAU taken along the line B-B′ in the figure with the letter A in the same figure number.

Referring now to FIGS. 2A-2C, which shows details of a FAU 400 according to some embodiments. Note that the FAU 400 is similar to the FAU 300 described above, except that the waveguide structure 306 is replaced with waveguides 410. Specifically, in the FAU 400, the waveguide structure 306 is omitted, and waveguides 410 are formed within the substrate 303 (e.g., at a certain depth below the upper surface 303C) in the second region R2. Similar to the waveguides 307 described above, in a plan view (see FIG. 2A), the waveguides 410 are parallel to each other and aligned with the fiber grooves 305 in a one-to-one fashion. In addition, although not shown, the waveguides 410 are positioned such that the core of each optical fiber 301 (held by a fiber groove 305) is aligned with the corresponding waveguide 410 (i.e., they are at the same vertical height) in cross-sectional view to allow optical coupling between the optical fibers 301 and the respective waveguides 410.

In some embodiments, the waveguides 410 are formed within the glass substrate 303 by an ion exchange process. For example, the ion exchange process replaces the original ions (such as Na⁺, K⁺, or the like) at the local position (where the waveguides 410 to be formed) of the glass substrate 303 with other types of ions (such as Ag⁺ or the like), thereby locally modifying the refractive index of the material at the local position. In some cases, the refractive index of the material at the local position may change (e.g., increase) by about 0.001 to 0.2 due to the ion exchange process. In this manner, the waveguides 410 can be directly formed (e.g., embedded) within the glass substrate 303. The waveguides 410 have the same function as that of the waveguides 307, so the description thereof is not repeated here.

In addition, since the waveguide structure 306 is omitted in the example of FIGS. 2A-2C, the one or more reflectors 309 are formed directly on the upper surface 303C near the second end 303B of the substrate 303. In such embodiments, the one or more reflective surfaces may be formed using techniques similar to those used to form the fiber grooves 305, such as imprinting, molding, mechanical cutting, laser cutting, chemical etching, or the like. In some embodiments, the one or more reflective surfaces and the fiber grooves 305 are formed in one step using the same process (e.g., imprinting process).

In an alternative embodiment, as illustrated in FIG. 2B-1, the waveguides 410 may be replaced by waveguides 411 formed using laser writing. For example, the laser writing process focuses the laser spot on the local position (where the waveguides 410 to be formed) of the glass substrate 303, thereby locally modifying the refractive index of the material at the local position using thermal energy. In some cases, the refractive index of the material at the local position may change (e.g., increase) by about 0.001 to 0.2 due to the laser writing process. In this manner, the waveguides 411 can be directly formed (e.g., embedded) within the glass substrate 303. Details of the waveguides 411 are similar to those of the waveguides 410.

In another alternative embodiment, as illustrated in FIG. 2B-2, the one or more reflectors 309 may also be replaced by one or more reflectors 409 formed using laser writing. By forming the one or more reflectors 409 directly in the glass substrate 303 using laser writing, processes for forming the reflective surfaces and reflective coatings can be omitted.

Referring now to FIGS. 3A-3C, which shows details of a FAU 500 according to some embodiments. Note that the FAU 500 is similar to the FAU 400 described above, except that the waveguides 410 in the second region R2 are omitted, and reflectors 309 are positioned adjacent to the fiber grooves 305. In a plan view (see FIG. 3A), the reflectors 309 are aligned with the fiber grooves 305 in a one-to-one fashion. In addition, although not shown, the reflectors 309 are positioned such that the core of each optical fiber 301 (held by a fiber groove 305) is aligned with the corresponding reflector 309 (i.e., they are at the same vertical height) in cross-sectional view to allow optical coupling between the optical fibers 301 and the respective reflectors 309 (i.e., light from the optical fibers 301 can be guided by the reflectors 309). In some alternative embodiments, a single reflector 309 is used instead of multiple reflectors 309.

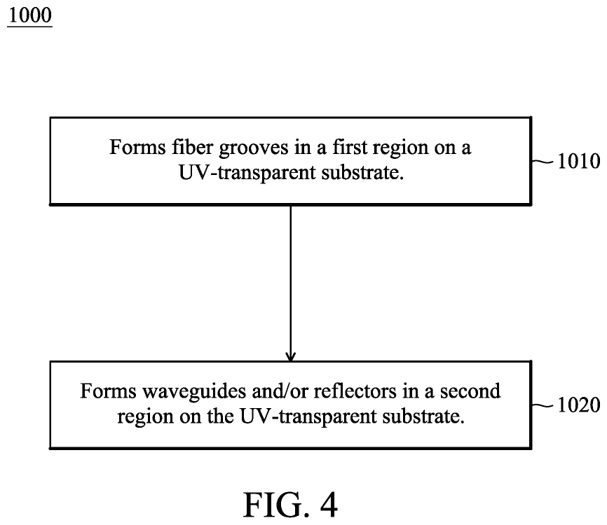

FIG. 4 illustrates a flow chart of a method 1000 of forming a FAU (e.g., the FAU 300, 400, or 500), in accordance with some embodiments. The method 1000 includes operation 1010, wherein fiber grooves (e.g., 305) are formed in a first region (e.g., R1) of a UV-transparent substrate (e.g., 303). The method 1000 also includes operation 1020, wherein waveguides (e.g., 307, 410, 411) and/or reflectors (e.g., 309, 409) are formed in a second region (e.g., R2) of the UV-transparent substrate.

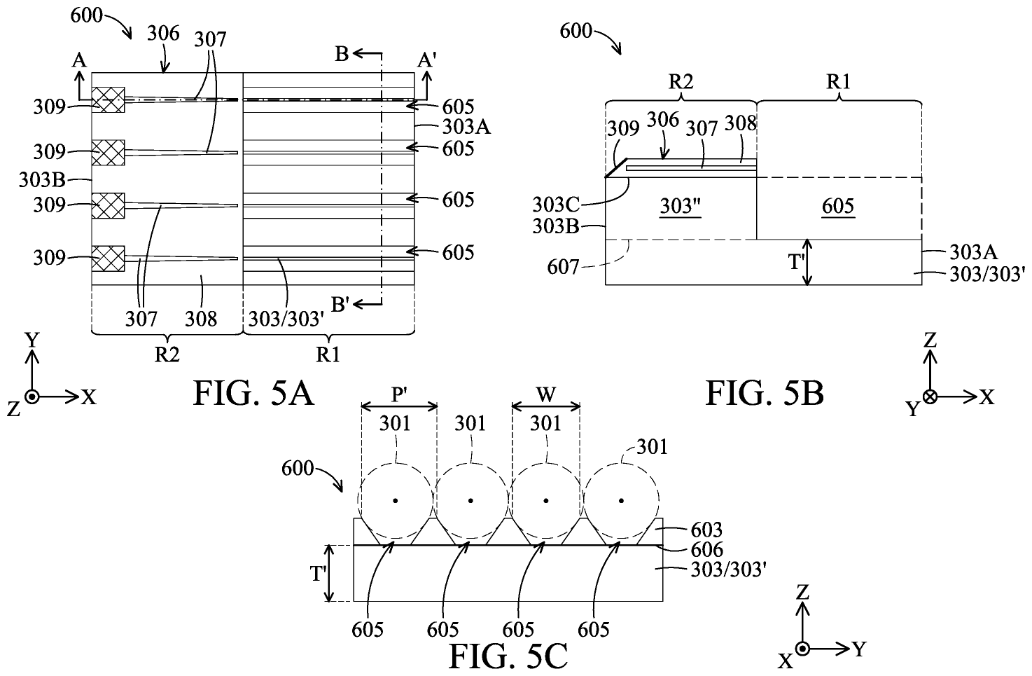

FIGS. 5A-5C illustrate various views of a FAU 600, in accordance with some embodiments. The FAU 600 is similar to the FAU 300 described above, except that the fiber grooves 305 are replaced by through-silicon grooves (TSVs) 605 formed in an additional silicon substrate 603. Specifically, in the FAU 600, the fiber grooves 305 are omitted (i.e., there is no fiber groove in the substrate 303), and through-silicon grooves 605 for holding the optical fibers 301 are formed to extend through top and bottom surfaces of a silicon substrate 603 (the arrangement of the through-silicon grooves 605 may be similar to that of the fiber grooves 305). The silicon substrate 603 is then attached (e.g., bonded) to the substrate 303 (e.g., glass substrate) by thermal bonding, such as a low-temperature direct bonding process (e.g., under a temperature below about 250° C.) or the like. The interface between the glass substrate 303 and the silicon substrate 603 is indicated by line 606 in FIG. 5C.

In such embodiments, during the curing process, light (e.g., UV light) can pass through the through-silicon grooves 605 and the glass substrate 303 to cure the underlying optical glue 217 (see FIG. 17). In addition, since the through-silicon grooves 605 are formed in the silicon substrate 603 using acceptable semiconductor fabrication processes (e.g., lithography and etching process), the dimension (e.g., the maximum width W′) and spacing (e.g., pitch P′) of the through-silicon grooves 605 can be smaller. This facilitates accommodating more and smaller optical fibers 301.

In some embodiments, during formation of the FAU 600, the silicon substrate 603 having the through-silicon grooves 605 is placed (e.g., mounted) in the recessed area of a pre-formed L-shaped glass substrate 303 (see FIG. 5B), and the waveguide structure 306 and reflectors 309 are subsequently formed on the raised portion of the L-shaped glass substrate 303 (similar to the embodiments of FIGS. 1A-1C).

In some alternative embodiments, during formation of the FAU 600, the silicon substrate 603 having the through-silicon grooves 605 is placed (e.g., mounted) in a first region R1 on a planar (e.g., flat) glass substrate 303′ (also referred to as a glass supporter 303′, e.g., the lower portion of the glass substrate 303), and a glass substrate 303″ (e.g., the upper portion of the glass substrate 303) is attached (e.g., bonded) to a second region R2 of the planar glass substrate 303′ (the interface in between is indicated by dashed line 607 in FIG. 5B). The waveguide structure 306 and reflectors 309 may be formed on the glass substrate 303″ before or after bonding the glass substrate 303″ to the glass supporter 303′. In some cases, the thickness T′ of the glass supporter 303′ may be in a range between 200 μm and 700 μm, although smaller or larger thicknesses may be used.

The functions and advantages of the FAU 600 are similar to those of the FAU 300 described above, so the description thereof is not repeated here.

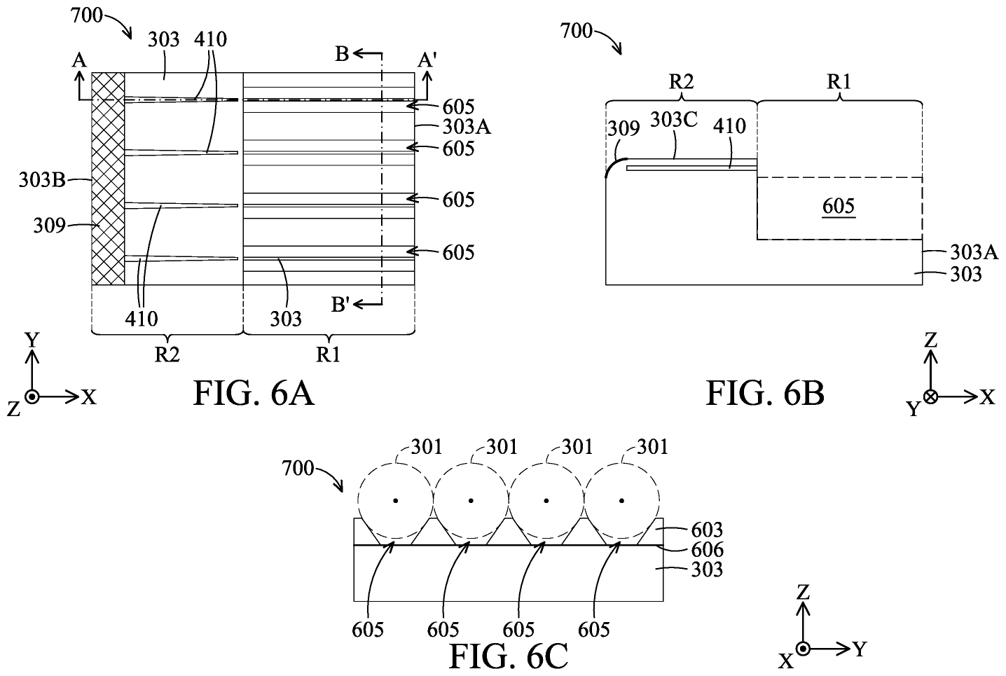

FIGS. 6A-6C illustrate various views of a FAU 700, in accordance with some embodiments. The FAU 700 is similar to the FAU 400 described above, except that the fiber grooves 305 are replaced by through-silicon grooves (TSVs) 605 formed in an additional silicon substrate 603, and the silicon substrate 603 having the TSVs 605 is mounted in the first region R1 on the glass substrate 303. The formation method, configuration and function of through-silicon grooves 605 have been described in the example of FIGS. 5A-5C, so the description thereof is not repeated here. In various embodiments, the waveguides 410 may be formed within the glass substrate 303 by an ion exchange process or a laser writing process, as described above.

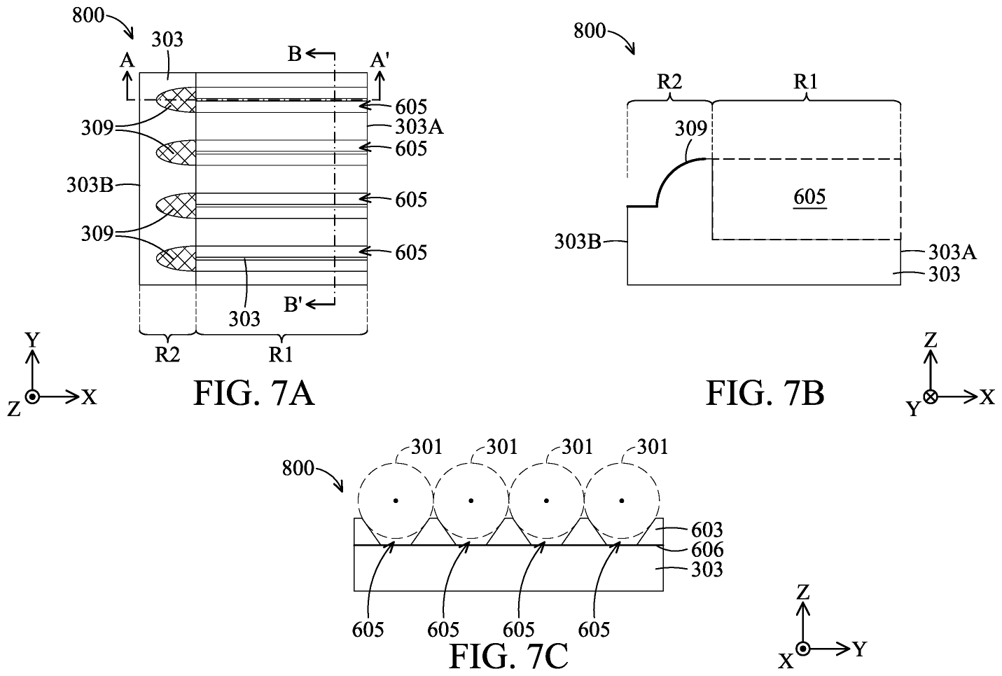

FIGS. 7A-7C illustrate various views of a FAU 800, in accordance with some embodiments. The FAU 800 is similar to the FAU 500 described above, except that the fiber grooves 305 are replaced by through-silicon grooves (TSVs) 605 formed in an additional silicon substrate 603, and the silicon substrate 603 having the TSVs 605 is mounted in the first region R1 on the glass substrate 303. The formation method, configuration and function of through-silicon grooves 605 have been described in the example of FIGS. 5A-5C, so the description thereof is not repeated here. In some embodiments, one or more reflectors 309 of the FAU 800 are formed on the upper surface 303C near the second end 303B of the substrate 303 using a technique described above for forming the reflectors 309 in the example of FIGS. 2A-2C. In other embodiments, similar to FIGS. 2B-2, one or more reflectors 409 may be formed directly in the glass substrate 303 using laser writing.

It should be understood that the structures, configurations and the manufacturing methods described herein are only illustrative, and are not intended to be, and should not be construed to be, limiting to the present disclosure. Many alternatives and modifications will be apparent to those skilled in the art, once informed by the present disclosure. For example, various features in the above-mentioned different embodiments can be combined arbitrarily.

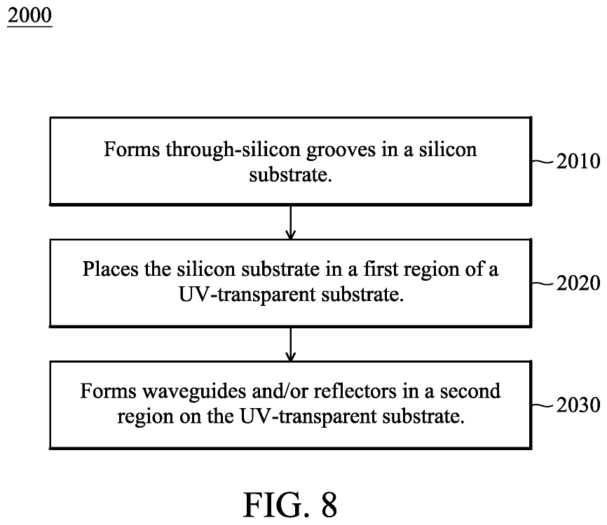

FIG. 8 illustrates a flow chart of a method 2000 of forming a FAU (e.g., the FAU 600, 700, or 800), in accordance with some embodiments. The method 2000 includes operation 2010, wherein through-silicon grooves (e.g., 605) are formed in a silicon substrate (e.g., 603). The method 2000 includes operation 2020, wherein the silicon substrate having the through-silicon grooves are mounted in (e.g., bonded to) a first region (e.g., R1) of a UV-transparent substrate (e.g., 303). The method 2000 includes operation 2030, wherein waveguides (e.g., 307, 410) and/or reflectors (e.g., 309) are formed in a second region (e.g., R2) of the UV-transparent substrate.

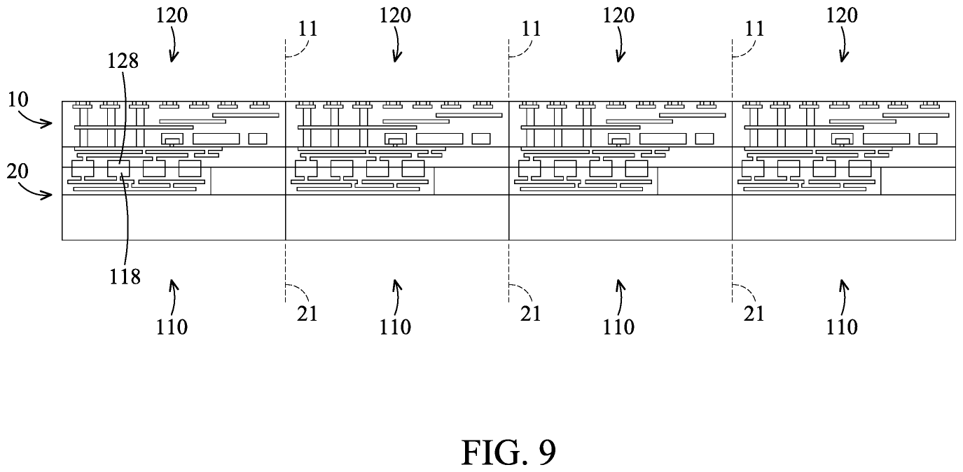

Next, a method of forming a photonic system (e.g., 200, illustrated in FIG. 17) including the above FAU (e.g., 300) in accordance with some embodiments of the present disclosure is described below in conjunction with FIGS. 9 to 17. Although the method embodiments may be discussed as being performed in a particular order, other method embodiments may be performed in any logical order.

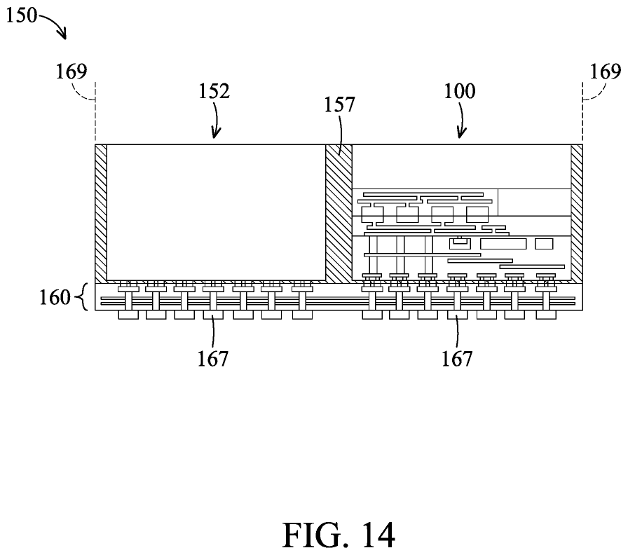

First, FIGS. 9 to 12 illustrate cross-sectional views of intermediate steps of forming a photonic package 100, in accordance with some embodiments. In some cases, the photonic package 100 may be part of a semiconductor package 150 (e.g., see FIG. 14) or another structure. The photonic package 100 may provide an input/output (I/O) interface between optical signals and electrical signals in the semiconductor package 150.

Referring to FIG. 9, a first side (e.g., the lower side shown in FIG. 9) of a wafer 10 is attached (e.g., bonded) to a front side of a wafer 20. The wafer 10 includes a plurality of photonic dies 120 separated by dicing regions. The locations of the dicing regions of the wafer 10 are indicated by lines 11 in FIG. 9. The wafer 20 includes a plurality of electronic dies 110 separated by dicing regions. The locations of the dicing regions of the wafer 20 are indicated by lines 21 in FIG. 9. Details of the photonic dies 120 and electronic dies 110 are illustrated and discussed below with reference to FIG. 12.

The wafer 10 is bonded to the wafer 20 by a suitable bonding process, such as by dielectric-to-dielectric bonding and/or metal-to-metal bonding (e.g., direct bonding, fusion bonding, oxide-to-oxide bonding, hybrid bonding, or the like). In such cases, covalent bonds may be formed between oxide layers, such as the topmost dielectric layer at the first side of the wafer 10 and the topmost dielectric layer at the front side of the wafer 20. During the bonding, metal bonding may also occur between die connectors 118 of the electronic die 110 and die connectors 128 of the photonic die 120. In the example of FIG. 9, dicing regions of the wafer 10 are aligned with respective dicing regions of the wafer 20 after the wafer bonding process.

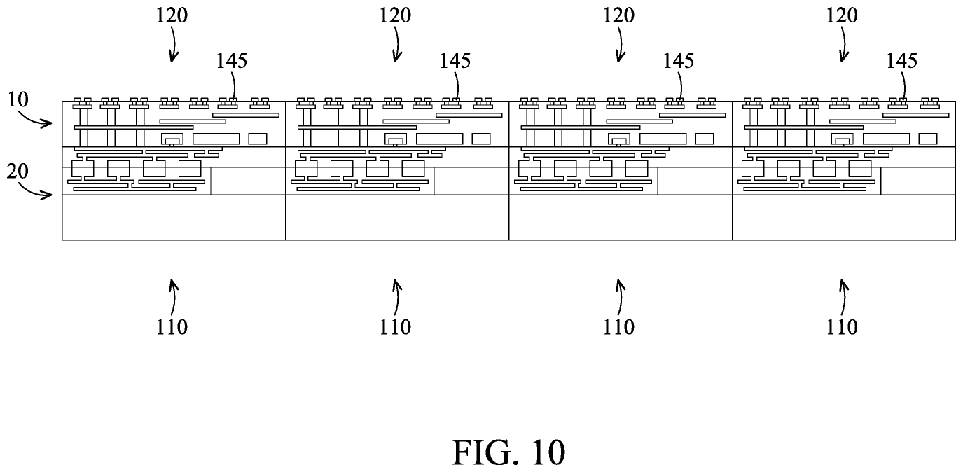

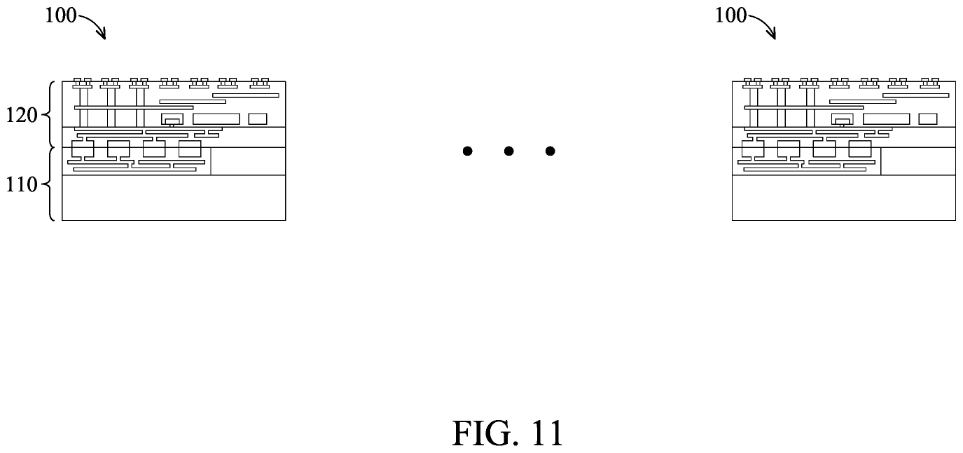

Next, in FIG. 10, conductive bumps 145 are formed on a second side (e.g., the upper side shown in FIG. 10) of the wafer 10 to electrically couple to conductive features (e.g., conductive pads and/or vias) of the photonic dies 120. After a subsequent dicing process (see FIG. 11) to form individual photonic packages 100, the conductive bumps 145 serves as the external connectors of the photonic package 100. The conductive bumps 145 may be any suitable type of external connectors, such as ball grid arrays (BGAs), solder balls, metal pillars, controlled collapse chip connection (C4) bumps, micro bumps, electroless nickel-electroless palladium-immersion gold technique (ENEPIG) formed bumps, or the like, and may comprise a conductive material such as solder, copper, aluminum, gold, nickel, silver, palladium, tin, the like, or a combination thereof.

Next, in FIG. 11, a dicing process is performed along the dicing regions of the wafers 10 and 20 to produce a plurality of individual (e.g., separate) photonic packages 100, where each photonic package 100 includes a photonic die 120 attached (e.g., bonded) to an electronic die 110. The dicing process may be performed using a blade, or a laser cutting tool, as examples.

Referring now to FIG. 12, which shows details of the photonic package 100. Note that the photonic package 100 in FIG. 12 corresponds to the photonic package 100 in FIG. 11, but flipped upside down. In the example of FIG. 12, the photonic package 100 includes the electronic die 110 attached (e.g., bonded) to the photonic die 120.

The electronic die 110 may be, for example, a semiconductor device, die, or chip that communicates with the photonic die 120 using electrical signals. In the illustrated embodiments, the electronic die 110 does not receive, transmit, or process optical signals. In the discussion herein, the term “electronic die” is used to distinguish it from “photonic die” (e.g., 120), which refers to a die that can receive, transmit, or process optical signals, such as converting an optical signal into an electric signal, or vice versa. Besides optical signals, the photonic die 120 may also transmit, receive, or process electrical signals. One electronic die 110 is shown in FIG. 12, but the photonic package 100 may include two or more electronic dies 110 in other embodiments. In some cases, multiple electronic dies 110 may be incorporated into a single photonic package 100 in order to reduce processing cost.

In some embodiments, the electronic die 110 includes a substrate 111 (e.g., a semiconductor substrate such as silicon or the like). Electronic components (not illustrated for simplicity), such as transistors, diodes, capacitors, resistors, etc., may be formed in and/or on the substrate 111 and may be interconnected by an interconnect structures 112 to form an integrated circuit. The interconnect structures 112 may be formed by, for example, metallization patterns (e.g., conductive lines 115 and vias 117) in one or more dielectric layers 113 over the substrate 111. The electronic die 110 further includes conductive pads (not illustrated for simplicity), such as aluminum pads, to which external connections are made. The conductive pads are located on what may be referred to as the active side (or front side) of the electronic die 110. One or more passivation layers (not illustrated for simplicity) are formed at the front side of the electronic die 110 and on portions of the conductive pads. Die connectors 118, such as conductive pillars (for example, including a metal such as copper), are formed to extend through the passivation layer(s) and are mechanically and electrically coupled to the respective conductive pads. The die connectors 118 are electrically coupled to the integrated circuits of the electronic die 110.

Note that in the example of FIG. 12, portions of the dielectric layers 113 of the electronic die 110 that have no functional circuit are replaced by a dielectric material 119. The dielectric material 119 may be a gap-fill material in some embodiments, which may include silicon oxide, silicon nitride, a polymer, the like, or a combination thereof. In some embodiments, the dielectric material 119 may be a material (e.g., silicon oxide) that is substantially transparent to light at wavelengths suitable for transmitting optical signals or optical power between optical components (e.g., grating couplers 138) of the photonic die 120 and a plurality of optical fibers (see, e.g., 301 in FIG. 17) attached to the photonic package 100.

The electronic die 110 may include integrated circuits for interfacing with a photonic component 137 (e.g., a photodetector and/or a modulator) of the photonic die 120. The electronic die 110 may include circuits for controlling the operation of the photonic components 137. For example, the electronic die 110 may include controllers, drivers, transimpedance amplifiers, the like, or combinations thereof. The electronic die 110 may also include a central processing unit (CPU), in some embodiments. In some embodiments, the electronic die 110 includes circuits for processing electrical signals received from the photonic component 137 including a photodetector. The electronic die 110 may control high-frequency signaling of the photonic components 137 according to electrical signals (digital or analog) received from another device or die, in some embodiments. In some embodiments, the electronic die 110 may be an electronic integrated circuit (EIC) or the like that provides Serializer/Deserializer (SerDes) functionality. In this manner, the electronic die 110 may act as part of an I/O interface between optical signals and electrical signals within the photonic package 100.

Still referring to FIG. 12, the photonic die 120 includes one or more dielectric layers 131, conductive features (e.g., conductive lines 133 and vias 135) formed in the dielectric layers 131, and various photonic devices formed in the dielectric layers 131, such as waveguides 136, photonic components 137, grating couplers 138 (only one photonic component 137 and one grating coupler 138 are shown in FIG. 12 for simplicity), nitride waveguides 139, or the like. In addition, the photonic die 120 includes an interconnect structure 122 over the dielectric layers 131, and conductive bumps 145 under the dielectric layers 131.

In some embodiments, the waveguides 136 are silicon waveguides formed by patterning a silicon layer. One waveguide 136 or multiple waveguides 136 may be patterned from the silicon layer. If multiple waveguides 136 are formed, the multiple waveguides 136 may be individual separate waveguides 136 or connected as a single continuous structure. In some embodiments, one or more of the waveguides 136 form a continuous loop. Due to the difference in the refractive indices of the materials of the waveguides 136 and dielectric layers 131, the waveguides 136 have high internal reflections so that light is substantially confined within the waveguides 136, depending on the wavelength of the light and the refractive indices of the respective materials. In some embodiments, the refractive index of the material of the waveguides 136 is higher than the refractive index of the material of the dielectric layers 131. For example, the waveguides 136 may comprise silicon, and the dielectric layers 131 may comprise silicon oxide and/or silicon nitride. Accordingly, the waveguides 136 may be referred to as “silicon waveguides” herein.

The photonic components 137 may be integrated with the waveguides 136, and may be formed with the waveguides 136. The photonic components 137 may be optically coupled to the waveguides 136 to interact with optical signals within the waveguides 136. The photonic components 137 may include, for example, photonic devices such as photodetectors and/or modulators. For example, a photodetector may be optically coupled to the waveguides 136 to detect optical signals within the waveguides 136 and generate electrical signals corresponding to the optical signals. A modulator may be optically coupled to the waveguides 136 to receive electrical signals and generate corresponding optical signals within the waveguides 136 by modulating optical power within the waveguides 136. In this manner, the photonic components 137 facilitate the input/output (I/O) of optical signals to and from the waveguides 136. In other embodiments, the photonic components 136 may include other active or passive components, such as laser diodes, optical signal splitters, or other types of photonic structures or devices. Optical power may be provided to the waveguides 136 by, for example, optical fibers 301 (see FIG. 17) attached to the photonic package 100. Contacts 132 (e.g., copper vias) are formed to electrically couple the photonic components 137 to the interconnect structure 122 of the photonic die 120.

The grating couplers 138 may be integrated with the waveguides 136, and may be formed with the waveguides 136. The grating couplers 138 are photonic structures that allow optical signals and/or optical power to be transferred between the waveguides 136 and another photonic component, such as external optical fibers 301 (see FIG. 17) or a waveguide of another photonic system.

FIG. 12 further illustrates a plurality of nitride (e.g., silicon nitride) waveguides 139 formed in different layers of the dielectric layers 131. The nitride waveguides 139 may provide additional optical signal routing and may be optically coupled to the waveguides 136. The nitride waveguides 139 may be formed by patterning silicon nitride layers. One nitride waveguide 139 or multiple nitride waveguides 139 may be formed by patterning a silicon nitride layer. If multiple nitride waveguides 139 are formed, the multiple nitride waveguides 139 may be individual separate nitride waveguides 139 or connected as a single continuous structure. In some embodiments, one or more of the nitride waveguides 139 form a continuous loop. Although not shown, the nitride waveguides 139 may include photonic structures such as grating couplers, edge couplers, or other types of couplers (e.g., mode converters) that allow optical signals to be transmitted between two nitride waveguides 139 and/or between a nitride waveguide 139 and a waveguide 136. The nitride waveguides 139 may be omitted in other embodiments.

FIG. 12 further illustrates the interconnect structure 122 of the photonic die 120. The interconnect structure 122 includes one or more dielectric layers 123, and conductive features (e.g., conductive lines 125 and vias 127) formed in the dielectric layers 123. Die connectors 128 (e.g., copper pillars, copper pads, or the like) of the photonic die 120 are formed on the upper surface of the photonic die 120 and are electrically coupled to the conductive features of the interconnect structure 122. The circuits of the electronic die 110 and the photonic components 137 of the photonic die 120 are electrically coupled through the interconnect structures 112, 122 and the die connectors 118, 128. The conductive features in the dielectric layers 123 and 131 electrically couple the die connectors 128 to the conductive bumps 145. In some embodiments, the dielectric layers 123 and 131 are formed of dielectric material (e.g., silicon oxide) that is substantially transparent to light at wavelengths suitable for transmitting optical signals.

Note that the type of components, the number of components, the arrangement/configuration of the components illustrated in FIG. 12 is merely a non-limiting example, other types/numbers of components, and other arrangement/configuration of the components are also possible, and are fully intended to be included within the scope of the present disclosure.

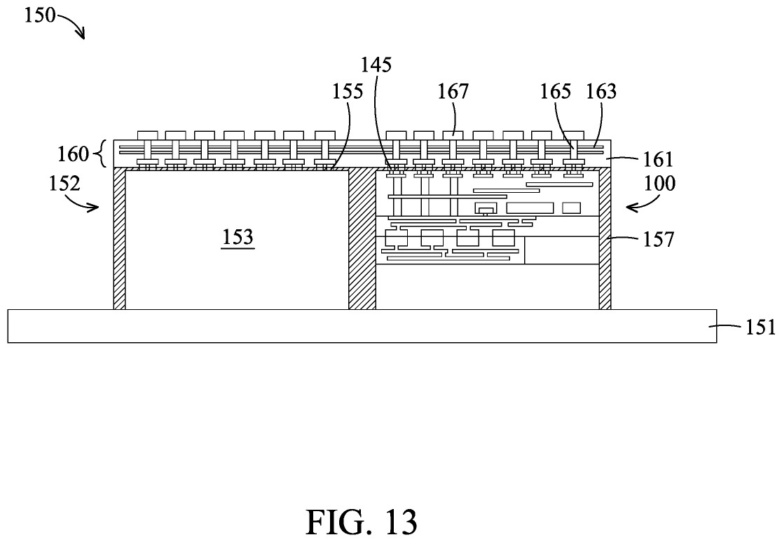

FIGS. 13 and 14 illustrate cross-sectional views of intermediate steps of forming a semiconductor package 150, in accordance with some embodiments. The semiconductor package 150 includes at least one photonic package 100 and at least one electronic die 152 interconnected by a redistribution structure 160 (also referred to as an interconnect structure 160), in some embodiments.

Referring to FIG. 13, a photonic package 100 and an electronic die 152 are attached to a carrier 151. The carrier 151 may be, for example, a glass carrier, a ceramic carrier, or the like. The photonic package 100 and the electronic die 152 may be attached to the carrier 151 using, for example, an adhesive or a release layer (not shown). The electronic die 152 may be, e.g., a CPU die, an application specific integrated circuit (ASIC) die, a high-bandwidth memory (HBM) die, or the like. The electronic die 152 may include a substrate 153, electronic components (not illustrated for simplicity) formed in and/or on the substrate 153, and interconnect structures (not illustrated for simplicity) connecting the electronic components to form functional circuits of the die. Die connectors 155 of the electronic die 152 provide electrical connection to the electronic die 152. Details of the electronic die 152 are similar to those of the electronic die 110 described above, and will not be repeated here. One photonic package 100 and one electronic die 152 are shown in FIG. 13, but the semiconductor package 150 may include other numbers of photonic packages 100 and/or electronic dies 152.

Next, a molding material 157 is formed on the carrier 151 and surrounds the photonic package 100 and the electronic die 152. For example, the molding material 157 may encapsulate the photonic package 100 and the electronic die 152. The molding material 157 is also formed in the gap between the photonic package 100 and the electronic die 152. The molding material 157 may be a molding compound, epoxy, or the like, and may be applied by compression molding, transfer molding, or the like. The molding material 157 may be applied in liquid or semi-liquid form and then cured. In some embodiments, a planarization process (e.g., a chemical mechanical polishing (CMP) process, grinding process, or the like) is performed after forming the molding material 157. After the planarization process, top surfaces of the molding material 157, the photonic package 100, and the electronic die 152 may be substantially level or coplanar.

Next, a redistribution structure 160 is formed over the molding material 157, and electrically coupled to the photonic package 100 and the electronic die 152. In some embodiments, the redistribution structure 160 includes one or more dielectric layers 161, and one or more layers of conductive features (e.g., conductive lines 163 and via 165) formed in the dielectric layers 161. In some embodiments, the one or more dielectric layers 161 are formed of a polymer, such as polybenzoxazole (PBO), polyimide, benzocyclobutene (BCB), or the like. In other embodiments, the dielectric layers 161 are formed of a nitride such as silicon nitride; an oxide such as silicon oxide, phosphosilicate glass (PSG), borosilicate glass (BSG), boron-doped phosphosilicate glass (BPSG); or the like. The one or more dielectric layers 161 may be formed by any acceptable deposition process, such as spin coating, chemical vapor deposition (CVD), laminating, the like, or a combination thereof. The conductive features 163/165 may be formed of a suitable conductive material such as copper, titanium, tungsten, aluminum, or the like. Further details of the redistribution structure 160 will not be described here.

Next, conductive bumps 167 are formed over and electrically coupled to the redistribution structure 160. Similar to the conductive bumps 145, the conductive bumps 167 may be any suitable type of external connectors, such as BGAs, solder balls, metal pillars, C4 bumps, micro bumps, ENEPIG formed bumps, or the like.

As skilled artisans readily appreciate, a plurality of (e.g., identical) semiconductor packages 150 may be formed simultaneously (e.g., in the same processing steps) on the carrier 151. These semiconductor packages 150 will be separated by a subsequent dicing process to form individual, separate, semiconductor packages 150.

Next, in FIG. 14, the carrier 151 is removed by a carrier be-bonding process. The resulting structure of FIG. 13 is then flipped over, and the conductive bumps 167 are attached to a dicing tape (not shown). Next, a dicing process is performed along lines 169 to produce a plurality of individual (e.g., separate) semiconductor packages 150 as illustrated in FIG. 14. The dicing process may be performed using a blade, or a laser cutting tool, as examples.

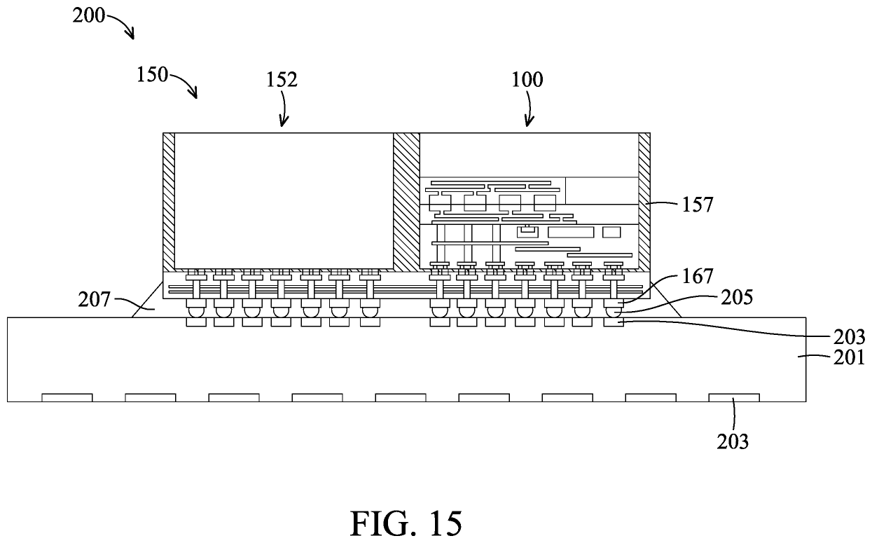

FIGS. 15 to 17 illustrate cross-sectional views of intermediate steps of forming a photonic system 200, in accordance with some embodiments. The photonic system 200 includes at least one semiconductor package 150 that is optically coupled to an optical fiber array unit (FAU) 300 including a plurality of optical fibers 301. In this manner, optical signals and/or optical power may be transmitted to or from the semiconductor package 150. For example, optical signals may be transmitted from the optical fibers 301 into the semiconductor package 150. The optical signals may be processed or analyzed by the semiconductor package 150, and then the semiconductor package 150 may generate and transmit other optical signals to the optical fibers 301. This is an example, and other applications are possible.

In FIG. 15, a semiconductor package 150 is attached (e.g., bonded) to a substrate 201. The substrate 201 may be an interposer, a semiconductor substrate, a redistribution structure, a core substrate, or the like. The substrate 201 may include conductive pads 203 formed on its upper and lower surfaces, and conductive features (e.g., conductive lines and/or vias, not shown for simplicity) connecting the conductive pads 203 on both sides of the substrate 201. In some embodiments, the substrate 201 includes active and/or passive devices. In other embodiments, the substrate 201 is free of active and/or passive devices. In some embodiments, the semiconductor package 150 is bonded to the substrate 201 by placing the conductive bumps 167 of the semiconductor package 150 above the upper conductive pads 203 of the substrate 201 and then performing a reflow process. In this manner, the semiconductor package 150 may be physically and electrically coupled to the substrate 201 (e.g., through conductive structures 205 such as solder materials disposed between the conductive bumps 167 and upper conductive pads 203).

Next, an underfill material 207 is formed on the substrate 201 and surrounds surround the semiconductor package 150. The underfill material 207 may flow underneath the semiconductor package 150 and into gaps between the conductive structures 205 to enhance the connection between the semiconductor package 150 and the substrate 201. The underfill material may include an epoxy, a resin, a filler material, a stress release agent (SRA), an adhesion promoter, another suitable material, or a combination thereof. In some embodiments, the underfill material may be applied in liquid form and then cured.

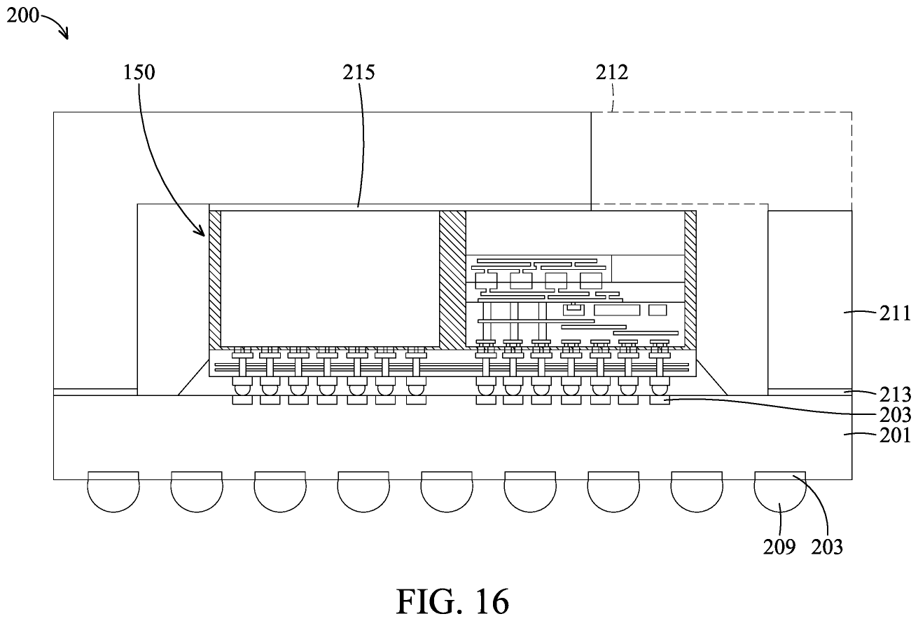

Next, in FIG. 16, a lid 211 is attached to the substrate 201. The lid 211 may be attached to the substrate 201 by, e.g., an adhesive material 213. The provision of the lid 211 helps to reduce warpage of the substrate 201. A center portion of the lid 211 may contact the electronic die 152 and the photonic package 100, either directly or through a thermal interface material (TIM) 215, in order to facilitate heat dissipation. In such cases, the material of the lid 211 may include metal such as copper, stainless steel, stainless steel/Ni, or the like, but is not limited thereto. In some embodiments, the lid 211 has at least one opening 212 in its top portion to allow attachment of, e.g., a FAU 300 (see FIG. 17) to the semiconductor package 150. In other embodiments, the lid 211 may be replaced by a stiffener ring, and the FAU 300 may pass through the hollow center portion of the stiffener ring and be attached to the semiconductor package 150.

External connectors 209, such as solder balls, are subsequently formed on the lower surface of the substrate 201 and connected to the lower conductive pads 203 such that the photonic system 200 can be coupled to another electronic device or system.

Next, in FIG. 17, a FAU 300 is attached to the top of the semiconductor package 150 (e.g., attached to the substrate 111 of the electronic die 110) through the opening 212 of the lid 211 by, e.g., an optical glue 217. After the optical glue 217 is dispensed between the FAU 300 and the semiconductor package 150, it can be cured, e.g., by ultraviolet (UV) curing, in some cases. Each optical fiber 301 of the FAU 300 is optically coupled to a corresponding grating coupler 138 within the photonic die 120 (see FIG. 12) within the semiconductor package 150 such that optical signals and/or optical power may be transmitted between the semiconductor package 150 and the optical fibers 301. In some cases, the end of each optical fiber 301 that is opposite the semiconductor package 150 may be coupled to an optical interconnect (e.g., an MT ferrule or the like, not shown) that is coupled to a light source (not shown).

In some embodiments, the FAU 300 includes a substrate 303 (also referred to as a base plate 303) integrating fiber grooves (e.g., recesses) and light guiding elements (e.g., the waveguides 307 and reflectors 309 illustrated in FIGS. 1A-1C), so that the optical fibers 301 can be secured in the fiber grooves, and the optical signals from the optical fibers 301 can be guided (e.g., redirected) by the light guiding elements (as indicated by the arrow S in FIG. 17) to the corresponding grating couplers 138 within the semiconductor package 150 (or vice versa). When assembling the FAU 300, as shown in FIG. 17, the substrate 303 is attached (e.g., fixed) to the semiconductor package 150 by the optical glue 217. In addition, a cover 302 may be present over the substrate 303 to cover and protect the optical fibers 301 and the light guiding elements, and an optical glue 304 may be distributed in the gap between the substrate 303, the cover 302, the optical fibers 301 and the light guiding elements for connecting these components.

Note that in the example of FIG. 17, the FAU 300 is placed on the top of the semiconductor package 150 instead of near the sidewall of the semiconductor package 150. This avoids the issue that the space (e.g., height) between the optical couplers (e.g., edge couples) within the photonic die 120 and the substrate 201 may be insufficient to accommodate the FAU 300 for optical coupling. In other embodiments, the FAU 300 may be replaced by the embodiment FAU 400, 500, 600, 700, or 800 described above.

Embodiments of the FAU discussed herein may have advantages. The fiber grooves and the light guiding elements (e.g., waveguides and/or reflectors) are integrated in a single support substrate, therefore no additional assembly alignment between the fiber grooves and the light guiding elements is required, thereby reducing the number of steps to manufacture the FAU. Also, the optical performance of the FAU can be improved due to the omission of an adhesive interface (such as optical glue) between the fiber grooves and the light guiding elements. Moreover, the support substrate can be made of a UV-transparent material to allow UV light to pass through during the curing process to cure the optical glue, so that the FAU can be well attached to the semiconductor package in the photonic system.

In accordance with some embodiments, a fiber array unit (FAU) is provided. The FAU includes a substrate, fiber grooves, and light guiding elements. The substrate has a first region and a second region which are continuous and connected. The fiber grooves are formed in the first region. The light guiding elements are formed in the second region. The fiber grooves are aligned with the light guiding elements, respectively.

In accordance with some embodiments, a method of forming a FAU is provided. The method includes providing a substrate comprising a material that allows ultraviolet (UV) light to pass through. The method includes forming fiber grooves in a first region of the substrate. The method includes forming light guiding elements in a second region of the substrate, wherein the first region and the second region are continuous and connected.

In accordance with some embodiments, a FAU is provided. The FAU includes a glass substrate, fiber grooves, waveguides, and at least one reflector. The glass substrate has a first region and a second region which are continuous and connected. The fiber grooves are formed in the first region. The waveguides are formed in the second region and aligned with the fiber grooves, wherein no adhesive is formed between one of the waveguides and a corresponding one of the fiber grooves. The at least one reflector is formed at one end opposite the fiber grooves in the second region.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A fiber array unit (FAU), comprising:
a substrate having a first region and a second region which are continuous and connected;
a plurality of fiber grooves formed in the first region; and
a plurality of light guiding elements formed in the second region, wherein the fiber grooves are aligned with the light guiding elements, respectively.

2. The fiber array unit as claimed in claim 1, wherein the substrate comprises a material that allows ultraviolet (UV) light to pass through, the material comprising glass, sol-gel glass or UV-transparent polymers.

3. The fiber array unit as claimed in claim 1, wherein the fiber grooves are formed on and recessed from an upper surface of the substrate.

4. The fiber array unit as claimed in claim 1, wherein the fiber grooves are through-silicon grooves formed in a silicon substrate, and the silicon substrate is placed on the substrate comprising a glass material.

5. The fiber array unit as claimed in claim 1, wherein the plurality of light guiding elements comprises:
a plurality of waveguides extending from an end of the second region adjacent to the plurality of fiber grooves to an opposite end of the second region away from the plurality of fiber grooves; and
at least one reflector disposed near an end of each waveguide of the plurality of waveguides that is opposite the plurality of fiber grooves.

6. The fiber array unit as claimed in claim 5, wherein the plurality of waveguides is formed in one or more dielectric layers above an upper surface of the substrate, and the at least one reflector is formed at an end of the one or more dielectric layers opposite the plurality of fiber grooves.

7. The fiber array unit as claimed in claim 5, wherein the plurality of waveguides is formed within the substrate below an upper surface of the substrate.

8. The fiber array unit as claimed in claim 7, wherein the at least one reflector is formed on the upper surface of the substrate near the end of the each waveguide opposite the plurality of fiber grooves.

9. The fiber array unit as claimed in claim 7, wherein the at least one reflector is formed within the substrate near the end of the each waveguide opposite the plurality of fiber grooves.

10. The fiber array unit as claimed in claim 1, wherein the plurality of light guiding elements comprises a plurality of reflectors disposed near an end of each waveguide of the plurality of waveguides that is opposite the plurality of fiber grooves.

11. A method of forming a fiber array unit (FAU), comprising:
providing a substrate comprising a material that allows ultraviolet (UV) light to pass through;
forming a plurality of fiber grooves in a first region of the substrate; and
forming a plurality of light guiding elements in a second region of the substrate, wherein the first region and the second region are continuous and connected.

12. The method as claimed in claim 11, wherein the material of the substrate comprises glass, sol-gel glass or UV-transparent polymers.

13. The method as claimed in claim 11, wherein forming the plurality of fiber grooves comprises forming the plurality of fiber grooves on an upper surface of the substrate.

14. The method as claimed in claim 11, wherein forming the plurality of fiber grooves comprises forming a plurality of through-silicon grooves in a silicon substrate, and bonding the silicon substrate having the plurality of through-silicon grooves to the substrate.

15. The method as claimed in claim 11, wherein forming the plurality of light guiding elements comprises:
forming a plurality of waveguides in one or more dielectric layers above an upper surface of the substrate; and
forming at least one reflector at an end of the one or more dielectric layers opposite the plurality of fiber grooves.

16. The method as claimed in claim 11, wherein forming the plurality of light guiding elements comprises forming a plurality of waveguides within the substrate below an upper surface of the substrate by an ion exchange process or a laser writing process.

17. The method as claimed in claim 16, wherein forming the plurality of light guiding elements further comprises forming at least one reflector on the upper surface of the substrate near an end of each waveguide of the plurality of waveguides opposite the plurality of fiber grooves, and the at least one reflector comprises a reflective coating.

18. The method as claimed in claim 16, wherein forming the plurality of light guiding elements further comprises forming at least one reflector within the substrate near the end of each waveguide of the plurality of waveguides opposite the plurality of fiber grooves using a laser writing.

19. A fiber array unit (FAU), comprising:
a glass substrate having a first region and a second region which are continuous and connected;
a plurality of fiber grooves formed in the first region;
a plurality of waveguides formed in the second region and aligned with the plurality of fiber grooves, wherein no adhesive is formed between one of the plurality of waveguides and a corresponding one of the plurality of fiber grooves; and
at least one reflector formed at one end opposite the plurality of fiber grooves in the second region.

20. The fiber array unit as claimed in claim 19, wherein:
each fiber groove of the plurality of fiber grooves extends in a first direction along which the first region and the second region are arranged; and
each waveguide of the plurality of waveguides extends in the first region.
